(19) United States
(12) Patent Application Publication
(10) Pub. No.: US 2018/0240082 A1
(43) Pub. Date: Aug. 23, 2018

(54) METHOD AND SYSTEM FOR THE FAIR AND TRANSPARENT ECONOMIC SHARE IN PROFITS FOR AUTHORS OF USER-GENERATED DATA IN SOCIAL COMMERCE PLATFORMS

(71) Applicant: Siemens Aktiengesellschaft, München (DE)

(72) Inventor: MANFRED LANGEN, MÜNCHEN (DE)

(21) Appl. No.: 15/902,471

(22) Filed: Feb. 22, 2018

(30) Foreign Application Priority Data
Feb. 23, 2017 (DE) 10 2017 2029 63.3

(51) Int. Cl. G06Q 20/02; A63F 11/00

(52) U.S. Cl. CPC G06Q 20/02; H04W 4/021; A63F 11/0051

(57) ABSTRACT

Provided is a method and a system for providing authors of user-generated data with a transparent and fair share in the economic profit produced from these data within the scope of a social commerce platform of a user community, in which a respective relative game result share is calculated for a respective author of user-generated data, for example annotated travel movement profiles, on the basis of gamification categories relevant to a performance indicator, for example the number of calls and user ratings, in which the total economic profit of the social commerce platform produced from the user-generated data is determined on the basis of at least one performance indicator of the social commerce platform, and in which a respective share in the economic profit is determined for the respective author of user-generated data by multiplying the total economic profit by the respective relative game result share.

### CROSS-REFERENCE TO RELATED APPLICATION

This application claims priority to German application No. 10 2017 202 963.3 having a filing date of Feb. 23, 2017, the entire contents of which are hereby incorporated by reference.

### FIELD OF TECHNOLOGY

The following relates to a computer-implemented method and a system for rewarding authors of user-generated data in social commerce platforms.

### BACKGROUND

Only methods and systems in which prizes/awards, which reward the best within a ranking after a predefined time (“challenge”, “competition”), are offered have hitherto been known.

### SUMMARY

An aspect relates to a computer-implemented method and a system in which authors of user-generated data are provided with a transparent and fair share in the actual economic profit produced from said data and the largest possible number of active users is achieved.

The following relates substantially to a method and a system for providing authors of user-generated data with a transparent and fair share in the economic profit produced from these data within the scope of a social commerce platform of a user community, in which a respective relative game result share is calculated for a respective author of user-generated data, for example annotated automatically captured travel movement profiles, on the basis of gamification categories relevant to a performance indicator, for example the number of calls and ratings by other users, in which the total economic profit of the social commerce platform produced from the user-generated data is determined on the basis of at least one performance indicator of the social commerce platform, and in which a respective share in the economic profit is determined for the respective author of user-generated data by multiplying the total economic profit by the respective relative game result share.

### BRIEF DESCRIPTION

Some of the embodiments will be described in detail, with reference to the following figures, wherein like designations denote like members, wherein:

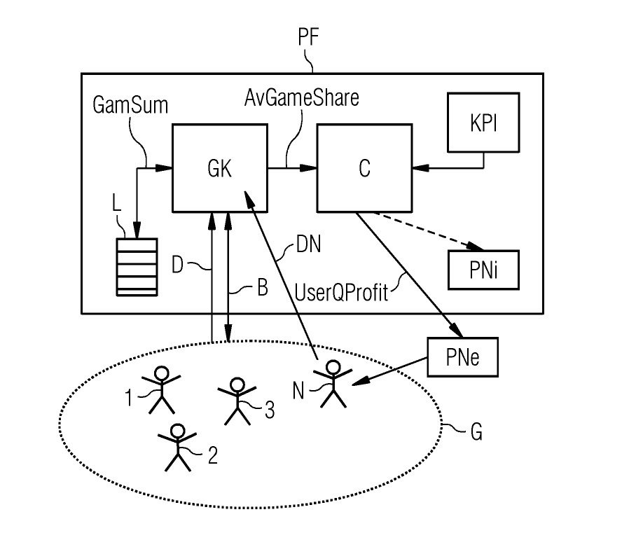

FIG. 1 depicts a schematic view of a social commerce platform of a user community, in accordance with embodiments of the present invention.

### DETAILED DESCRIPTION

FIG. 1 shows a social commerce platform PF of a user community G with users 1, 2, 3 and N which are illustrated by way of example and provide the platform with data D and ratings B which in turn result in an aggregated game result value GamSum in a player list L for each user with the aid of gamification categories GK relevant to a performance indicator. In this case, data DN provided by the user N are rated B by other users 1, 2 and 3. Respective relative game result shares AvGameShare are calculated with the aid of these game result values GamSum in the list L. On the basis of at least one performance indicator KPI (key performance indicator) and the respective relative game result share AvGameShare, for example a temporal average value of the respective relative game result share, a respective share UserQProfit in the economic profit from his data is determined for the respective author of user-generated data in the form of a currency which is valid only inside the platform PNi or a currency which is valid outside the platform PNe, for example Euro or Bitcoin, and is distributed.

In the method according to embodiments of the invention, a respective relative game result share AvGameShare is calculated for a respective author of user-generated data D on the basis of gamification categories GK relevant to a performance indicator, total economic profits of the social commerce platform which are produced from the user-generated data are determined on the basis of at least the performance indicator KPI of the social commerce platform PF, and a respective share UserQProfit in the economic profit is determined for the respective author of user-generated data by multiplying the total economic profit by the respective relative game result share AvGameShare.

The relative game result share AvGameShare is calculated by virtue of the gamification categories GK relevant to a performance indicator providing a respective weighted contribution to an aggregated game result value GamSum for each user 1, 2, 3, N in the player list L, the aggregated game result value GamSum being the result of the respective activities of the user, and the absolute number being increased by activity and, in the absence of activity, being reduced by temporally reducing the rating in the summation algorithm, and by virtue of the respective aggregated game result value being divided by the sum of the aggregated game result values of all users.

The player list L can be advantageously dynamically managed as a ranking list in a manner organized according to the aggregated game result values GamSum.

In this case, the gamification categories GK relevant to a performance indicator or KPI typically contain query frequencies and/or user ratings B of the data.

Such gamification categories relevant to a KPI are, for example, usage/request numbers, ratings of this queried information by requesting other users or comments and feedback relating to how helpful this information was, ratings of the knowledge content and, for example, statements with regard to how quickly urgent requests with respect to problems were answered.

Finally, it is also possible to use aggregated KPIs such as “resonance” and “range” (“digital influence”)—cf., in this respect, US2016/0140186A1, title: Identifying Subject Matter Experts, Manfred Langen.

Performance indicators or KPIs (key performance indicator) of such a social commerce platform PF (community platform) are typically the market value on the stock market or the efforts made by venture capitalists, the quarterly/annual turnover, the quarterly/annual profit or per capita values for turnover and profit.

A system according to embodiments of the invention for providing authors of user-generated data with a share in the economic profit produced from these data within the scope of a social commerce platform calculates, for a given interval of time, for example for a quarter, a respective average relative game result share AvGameShare for a respective author of user-generated data on the basis of gamification categories GK relevant to a performance indicator, the game results of the respective author being averaged over the interval of time, for example, and the sum of all game results averaged in this manner being used as a basis. The total economic profit of the social commerce platform which is produced from the user-generated data for the given interval of time is then determined on the basis of performance indicators KPI of the social commerce platform PF, from which a particular percentage is determined as the total profit ComQProfit of the community.

Finally, a respective profit UserQProfit for the given interval of time is then determined C for the respective author of user-generated data by multiplying the total profit by the respective average relative game result share AvGameShare and is distributed.

UserQProfit=ComQProfit*AvGameShare

The respective average relative game result share AvGameShare is advantageously calculated by rating user-generated data for a respective author during his activities on the basis of gamification categories GK relevant to the performance indicators KPI of the social commerce platform and aggregating them to form the respective result value GamSum, this respective result value being increased by activity of the respective user and being reduced by the absence of activity in a time-dependent manner, and by adding the respective result values of all users to form a total game result value and forming the respective game result shares AvGameShare by dividing the respective game result value by the total game result value.

The percentage for determining the total profit can optionally be varied depending on the level of maturity of the user community.

The respective profit UserQProfit can optionally be distributed in the form PNi of a currency peculiar to the user community or discounts which can be used only for purchases within the social commerce platform or else in the form PNe of a general currency which is also externally valid, for example Euro or Bitcoins. The resulting monetary incentive UserQProfit can therefore be either directly transferred as a sum of money—such as a dividend—or can be provided as credit for purchases within the platform.

In this context, user-generated data are, for example, automatically captured geographical data relating to a movement profile of a user during his journey and/or geographically associated contents input by the user.

The following explained using the specific example of a “Connected Mobility Platform”:

Mobility services are offered on a so-called Connected Mobility Platform or CML by various providers, for example public transport, rental car, car sharing, bike sharing, long-distance coach and train, and are combined to form an overall journey. Users compile a journey and purchase an overall ticket.

By means of a community approach, the users are intended to be motivated to actively participate in the platform in order to thus increase customer loyalty. In order to analyze their “customer experience”, they are supposed to provide their experience on the way from A to B. This is carried out, on the one hand, automatically by recording the movement profile (subject to agreement) and actively via feedback, that is to say user-generated contents. This user-generated content may relate to infrastructure problems which hinder or make onward movement inconvenient, bottlenecks, mobile speed traps etc. Furthermore, users can form (car) pools, itineraries (technical) and travel reports (touristic).

The revenue from CML is typically determined by different business models. CML produces turnover by selling anonymized movement profiles, commission for the services offered which provides direct turnover in the platform, fees for services offered which do not provide any direct turnover in the platform, and the platform uses user profiles for targeted advertising in order to produce advertising revenue.

For example, a person has been a CML user for one year and has already planned and carried out numerous journeys via CML, has paid the costs via CML and has produced corresponding contents and feedback in the community. The person also provides the data relating to his movement profile for the duration of a journey.

The aggregated game result value GamSum of the person has increased, for example, from 180 to 220 in the last quarter and was 200 on average. It is therefore precisely at the average of the aggregated game result values of all 1 million users who were active in the last quarter and only those—a further incentive to remain active—are taken into account in the distribution. His average relative game result share AvGameShare is therefore one millionth.

The current quarterly profit is 20 million Euros. Of these, half goes to the owners and to the community members, that is to say total collective profit ComQProfit=10 million euros. As a community activist, this person therefore receives a profit share of 10 Euros which are credited to his CML account and can be used for the next travel reservation. If half of all users were simultaneously equal owners of the platform (cooperative), each would receive a stakeholder profit share of 20 Euros.

1. A computer-implemented method for providing authors of user-generated data with a share in an economic profit produced from the user-generated data within a scope of a social commerce platform of a user community, the method comprising:
calculating, by a processor of a computing system, a respective relative game result share for a respective author of the user-generated data on a basis of gamification categories relevant to a performance indicator;
determining, by the processor, a total economic profit of the social commerce platform which is produced from the user-generated data on a basis of at least one performance indicator of the social commerce platform; and
determining, by the processor, a respective share in the total economic profit for the respective author of user-generated data by multiplying the total economic profit by the respective relative game result share.

2. The method as claimed in claim 1, wherein the respective relative game result share is calculated by virtue of:
the gamification categories relevant to a performance indicator providing a respective weighted contribution to an aggregated game result value for each user in a player list, the aggregated game result value being the result of the respective activities of the user, and an absolute number being increased by activity and, in the absence of activity, being reduced by temporally reducing a rating in a sum algorithm; and
the respective aggregated game result value being divided by the sum of the aggregated game result values of all users.

3. The method as claimed in claim 2, wherein the player list is dynamically managed as a ranking list in a manner organized according to the aggregated game result values.

4. The method as claimed in claim 1, wherein the gamification categories contain at least one query frequency and/or at least one user rating B of the data.

5. A system for providing authors of user-generated data with a share in an economic profit produced from the user-generated data within a scope of a social commerce platform, the system comprising:
for a given interval of time, a respective average relative game result share that is calculated for a respective author of the user-generated data on a basis of gamification categories relevant to a performance indicator;
a total economic profit of the social commerce platform, which is produced from the user-generated data for the given interval of time and determined on a basis of performance indicators of the social commerce platform;
a particular percentage of the total economic profit that is determined as the total economic profit; and
a respective profit for the given interval of time, determined for the respective author of the user-generated data by multiplying the total economic profit by the respective average relative game result share , which is distributed.

6. The system as claimed in claim 5, wherein the respective average relative game result share is calculated by:
rating the user-generated data for a respective author during user activities on a basis of gamification categories relevant to the performance indicators of the social commerce platform and aggregating them to form a respective result value, the respective result value being increased by activity of the respective user and being reduced by the absence of activity in a time-dependent manner; and
adding the respective result values of all users to form a total game result value and forming respective game result shares by dividing the respective game result value by the total game result value.

7. The system as claimed in claim 5, wherein the percentage for determining the total economic profit is varied depending on a level of maturity of the user community.

8. The system as claimed in claim 5, wherein the respective profit is distributed in the form of a currency which is peculiar to the user community and can be used only for purchases within the social commerce platform.

9. The system as claimed in claim 5, wherein the respective profit is distributed in a form of a general currency which is also externally valid.

10. The system as claimed in claim 5, wherein the user-generated data is automatically captured geographical data relating to a movement profile of a user during a journey and/or geographically associated contents input by the user.
